(19) United States
(12) Patent Application Publication
(10) Pub. No.: US 2001/0034608 A1
(43) Pub. Date: Oct. 25, 2001

(54) Shipping method and system

(76) Inventor: Marc Gendreau, Ascot Corner (CA)

Correspondence Address: PILLSBURY & WINTHROP, Ninth Floor East Tower, 1100 New York Avenue, Washington, DC, 20005-3918, US

(21) Appl. No.: 09/789,813

(22) Filed: Feb. 22, 2001

Related U.S. Application Data
(60) Provisional application No. 60/183,824, filed on Feb. 22, 2000.

(51) Int. Cl. G06F 17/60

(52) U.S. Cl. 705/1; 705/410

(57) ABSTRACT

A method for determining an appropriate (e.g., least expensive) shipping carrier of a plurality of shipping carriers for a parcel comprises associating with the parcel computer-readable information relating to at least a destination, delivery date, and delivery mode of the parcel. The method further comprises measuring a weight and volume of the parcel and inputting the computer-readable information, weight, and volume into a computer. The method still further comprises using the computer, selecting the appropriate shipping carrier for the parcel. A system is also provided for determining a most appropriate shipping carrier.

This application claims priority to U.S. Provisional Patent Application Serial No. 60/183,824 filed on Feb. 22, 2000.

### FIELD OF THE INVENTION

The present invention relates to a method and a system for determining an appropriate shipping carrier of a plurality of shipping carriers for a parcel. For example, the appropriate carrier may be a least expensive carrier, or a carrier that satisfies the customer-selected criteria for a parcel.

### BACKGROUND OF THE INVENTION

Companies that package and ship large quantities of parcels have found it necessary to invest considerable resources in the individuals who prepare the parcels. The investment is needed because different parcel carriers, for example Federal Express® (FedEx®), United Parcel Service® (UPS®), etc., publish different postage rates for parcels of different weights, sizes, and levels of service (e.g., delivery date). Therefore, to save as much on postage as possible, or to select the most appropriate carrier based on a customer's needs, companies have provided considerable training to their parcel handlers who become intimately familiar with the different postage rates and services posted by commercial parcel carriers. The services, for example, could be COD, guaranteed delivery, signature upon delivery, etc.

Despite the training that is provided, it is difficult (if not impossible) for any one person or group of persons to assure that the most appropriate carrier is selected, or that the lowest postage rate is paid for a particular parcel, especially since rates are frequently changed.

Accordingly, a need developed for an apparatus and method that could automate the parcel shipping process.

### SUMMARY OF THE INVENTION

The shipping method and system of the present invention is designed so that parcels may be weighed, measured, and labeled in preparation for shipment to their final destinations. Since shipping is handled by existing mail, parcel, and express mail carriers, the method and system of the present invention is designed to select the most appropriate carrier, e.g., a carrier that offers the least expensive price for delivering the parcel to its final destination within the time constraints imposed by the customer. The method and system accomplish this function as set forth in the description that follows and as described in the pages appended to this description.

Briefly, the method and system of the present invention was developed, among other reasons, to facilitate shipping of parcels that may or may not be of uniform shape or weight. The present invention also accommodates the delivery schedule imposed by the customer for a particular parcel.

The exterior dimensions, weight, mode of delivery, destination and maximum delivery date of a parcel are some of the characteristics that shipping companies use to determine the cost for shipping a parcel from one location to another. Generally, the price for delivering a parcel increases with increased size, higher weight, and shorter delivery time. While this rule holds true generally, each delivery service publishes a different shipping schedule for parcels. Cost schedules change regularly, making it even more difficult to select the least expensive or most appropriate carrier. As a result, any given parcel will be subject to different shipping costs depending upon the carrier selected and the associated cost schedule.

In cases where a shipper sends parcels of differing weights, sizes, and delivery deadlines, it is often difficult to select a particular parcel carrier that will provide reliable service for the best price. Traditionally, to do this, shippers have invested considerable time and money to train an employee so that the employee has sufficient familiarity with shipping schedules to be able to select the least expensive or most appropriate service. Even with extensive training, an employee will not always select the optimal carrier especially since it is difficult to track changes to cost schedules and the services that carriers provide. As a result, even with months or years of familiarity with carriers, employees often cannot select the least expensive or most appropriate carrier every time.

The present invention eliminates the need to train an individual (or individuals) to select the least expensive parcel or most appropriate carrier because the present invention automates the entire process. The shipping process is faster and more efficient than the shipping process currently used.

A further difficulty with selecting the least expensive postal rate for a particular carrier arises when the parcel is unusually shaped, such as occurs when the item to be shipped is contained within a plastic bag or other variably-dimensioned container.

Therefore, it is an aspect of the present invention to provide an improved method and system for determining an appropriate shipping carrier for a parcel.

Another aspect of the present invention is to provide a method and system for determining an appropriate shipping carrier for a parcel that eliminates the need for trained individuals to select the appropriate carrier.

Still another aspect of the present invention is to provide a method and system for determining an appropriate shipping carrier for a parcel that accommodates unusually-shaped parcels.

According to one preferred embodiment, a method is provided for determining an appropriate shipping carrier from a plurality of shipping carriers for a parcel. The method includes providing computer-readable information (or at least associating computer-readable information with the parcel via an associated order request) relating to at least one of a destination, delivery date, and delivery mode of the parcel, obtaining a volume of the parcel, measuring a weight of the parcel, inputting the computer-readable information, weight, and volume into a computer, and selecting the appropriate shipping carrier for the parcel based on the computer-readable information, weight, and volume.

In embodiments, the computer-readable information may include a number of articles contained within the parcel, the method further comprising comparing the measured weight to a known weight per article times the number of articles to confirm that the predetermined number of articles is in the parcel.

The computer-readable information may also include an actual volume of the parcel, and the actual volume of the parcel rather than any measured volume of the parcel is used to select the appropriate shipping carrier. The appropriate carrier may be the least expensive carrier.

The method may further comprise comparing the computer-readable information of a next processed parcel with that of at least one previously processed parcel, utilizing a cost schedule of the appropriate shipping carrier for the previously processed parcel, if the computer-readable information of the next processed parcel is the same as the previously processed parcel, to determine an incremental cost increase for adding at least one of the additional weight, volume, and another carrier cost schedule parameter of the next processed parcel with that of the previously processed parcel, and selecting the shipping carrier of the previously processed parcel for the next processed parcel if the incremental cost increase is less than a cost for the next processed parcel by itself.

The method may also further comprise inputting into the computer shipping cost information regarding the plurality of shipping carriers and the selecting the appropriate carrier includes matching one of the shipping carriers having the least expensive shipping cost information based on the computer-readable information, the weight, and the volume of the parcel.

The method may still further comprise attaching a label to the parcel and directing the parcel to the appropriate shipping carrier.

According to another preferred embodiment, a system for determining the least expensive shipping carrier for a parcel comprises an input device constructed and arranged to read an invoice on (a paper invoice associated with) the parcel as the parcel moves along a conveying path. The invoice or invoice label (or at least associating computer readable information with the parcel via an associated order request) has bar coded information that includes at least one of a delivery destination, a delivery date, and a delivery mode of the parcel. The system includes a scanning device provided along the path. The scanning device is constructed and arranged to measure the dimensions of the parcel to determine the volume of the parcel. The system further includes a weighing device along the path. The weighing device is constructed and arranged to determine the weight of the parcel. The system still further includes a computer system to receive the information obtained by the input device, the scanning device, and the weighing device as the parcel moves along the path. The computer system selects the least expensive shipping carrier for the parcel based on a search conducted by the computer system that utilizes the information, the volume, and the weight of the parcel.

In embodiments, the system may further comprise a shipping label printer along the path, the shipping label printer being constructed and arranged to prepare a shipping label for the parcel of the least expensive shipping carrier. The system may further comprise a conveyor system to move the parcel along the path past the input device, the scanning device, the weighing device, and the shipping label printer. The computer system may verify contents of the parcel by comparing an average known weight of the contents to the actual weight of the parcel based on the weighing device. The invoice label may include the actual volume of the parcel, the actual volume on the invoice label overriding any volume obtained by the scanning device.

These and other aspects, features, and advantages of this invention will be described in or apparent from the following detailed description when taken in conjunction with the accompanying drawings, which are a part of this disclosure and which illustrate, by way of example, exemplary embodiments of the invention.

### BRIEF DESCRIPTION OF THE DRAWINGS

The accompanying drawings facilitate an understanding of the various embodiments of this invention. In such drawings:

FIG. 1 is a perspective view of a shipping system constructed according to an exemplary embodiment of the present invention illustrating the system processing a box-shaped parcel;

FIG. 2 is a perspective view of the shipping system shown in FIG. 1 illustrating the system processing an unusually-shaped parcel;

FIG. 3 is a cross-sectional view along line 3-3 of FIG. 1 illustrating a scanning device that determines the cubic dimensions of a parcel;

FIG. 4 is a schematic representation of an exemplary system according to the present invention; and

FIG. 5 is a flow chart of an exemplary method according to the present invention.

### BRIEF DESCRIPTION OF PREFERRED EMBODIMENTS

To illustrate the operation of the shipping system 11 of the present invention, two examples of its operation follow.

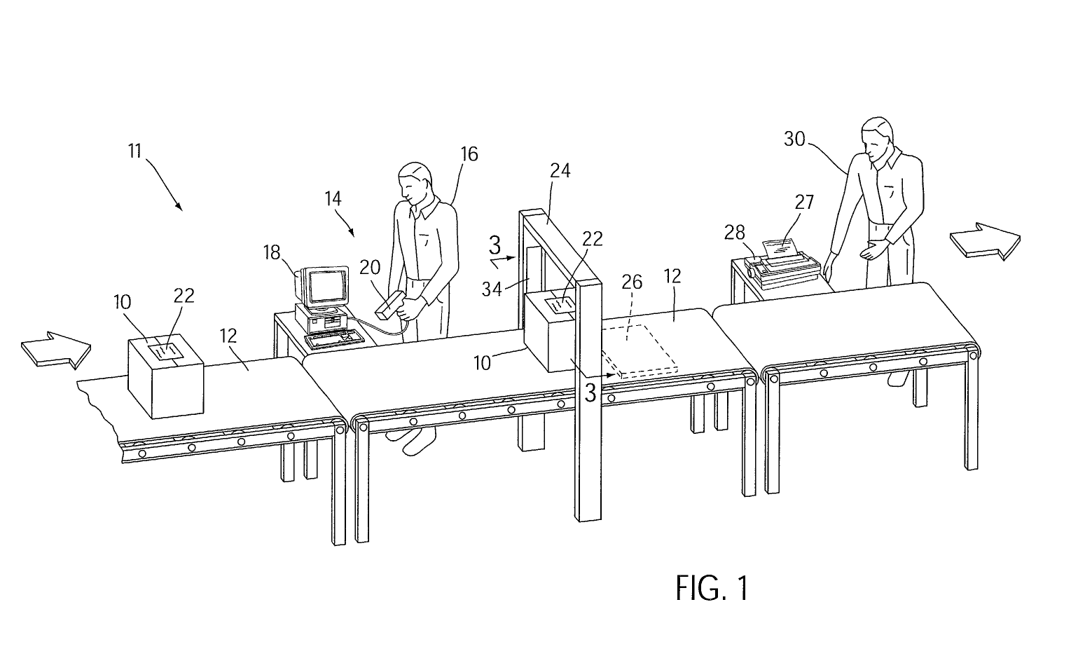

First, FIG. 1 illustrates a parcel in the form of a box 10 having, for example, external dimensions of 20×20×20 cm. Once the box 10 has been loaded with the item or items to be shipped, the box 10 is introduced into the shipping system 11 of the present invention on a conveyor system 12, which moves the box 10 along a conveying path.

The conveyor 12 moves the box 10 to station 14 where an operator 16 inputs computer-readable invoice information about the box 10 into a computer system 18. As shown, an input device 20, such as a bar code scanner, is used to read the computer-readable information relating to at least one of a destination, level of service (e.g., delivery date), and delivery mode of the parcel and to input the computer-readable information into the computer system 18. In one preferred embodiment of the present invention, the computer readable information that is read by the input device 20 may relate to the destination of the parcel, and no other information need be considered. The input device 20 may be automated or may be manually manipulated by the operator 16 as shown. It is also contemplated that any other type of input device that would be known to those skilled in the art may be used the read the computer-readable information and input the same into the computer system 18. When a bar code scanner 20 is used, the bar code may be read from an invoice 22, such as a bar code label having bar-coded information, that is associated with the box 10. The invoice 22 having computer-readable information may be provided on an outer surface of the box 10 as the box is manufactured or may be attached separately to the outer surface of the box 10, by an adhesive for example. Alternatively, the invoice 22 may be a printed document that travels with but is not connected to the parcel (i.e., at least associating computer-readable information with the parcel via an associated order request). Typically, the invoice 22 is created when an order is placed with the shipper who fills the order and packages the order into the box 10. The delivery mode (i.e. ground, air travel, etc.) may be included on the invoice 22 because certain parcels may necessitate a particular mode of travel. For example, hazardous materials may have to be ground transported for safety reasons.

After the computer-readable information is inputted into the computer system 18, the box 10 proceeds along the conveying path on the conveyor 12 through a scanning device 24 (e.g., a cubing machine), which measures the exterior dimensions of the box 10 in order to determine the cubic volume of box 10. Besides the dimensions, the scanning device 24 could be configured to measure other dimensions that are used by the carriers. (The scanning device 24 is described in greater detail below.) After the exterior dimensions of box 10 are inputted into the computer system 18, the box 10 proceeds down the conveyor 12 along the conveying path to a weighing device 26, or scale, where the weight of the box 10 is measured and inputted into the computer system 18. With these parameters inputted into the computer system 18, the computer system 18 searches through the delivery and cost schedules for the various parcel carriers (such as Federal Express®, United Parcel Service®, or an appropriate national mail carrier such as the United States Postal Service) within the system 18 and selects the most appropriate shipping carrier, e.g., the shipping carrier with the lowest cost, based on the computer-readable information, weight, and volume.

As the box 10 continues further down the conveyor 12 along the path, a label 27 is printed by a shipping label printer 28 for the appropriate shipping carrier, which is then attached to the box 10 by the operator 30. The label may be applied by the operator 30 as shown or the process of applying labels may be automated. The printer 28 prints labels 27 that may include tracking numbers, in accordance with the standards of the carriers. The system 18 also sends manifest and invoicing information in accordance with carrier standards. The box 10 may then be directed to the appropriate shipping carrier along the conveying path to the loading dock so that it may be shipped to its final destination.

It is contemplated that the boxes may be sorted automatically by a routing device, or sorter (not shown). The sorter may sort each of the boxes, by carrier for example, and direct each of the boxes along one of a plurality of delivery channels that branch out from the conveying path of the conveyor 12.

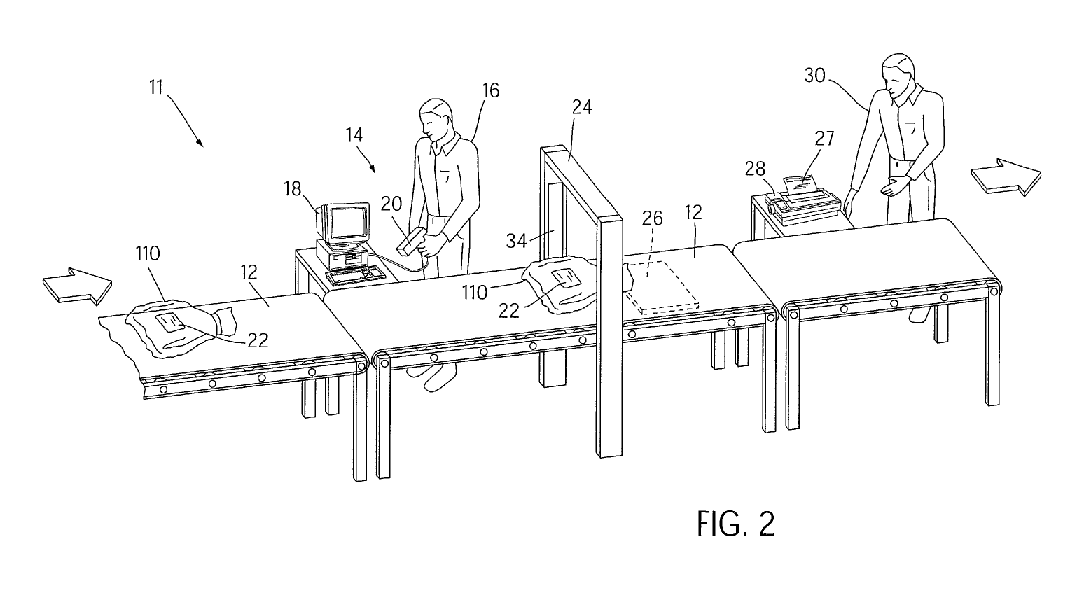

FIG. 2 illustrates a second operation of the system 11 of the present invention where an unusually-shaped parcel 110 is processed. In this example, the operation of the system 11 is the same as that described above, except the actual volume of the parcel 110 is included with the computer-readable information from the invoice 22. As mentioned above, the parcel 110 is unusually-shaped such as a plastic bag. The invoice 22 contains information about the actual dimensions or actual volume of the parcel 110. It is also contemplated that the operator 16 may select the container type (e.g., “plastic bag #1”) and the computer system 18 selects from memory the actual exterior dimensions of the container to determine the volume for shipping.

The parcel 110 then continues to travel along the conveying path through scanning device 24. When the parcel 110 (the unusually-shaped parcel) passes through the scanning device 24, the scanning device 24 measures the external dimensions of the parcel 110 just as it did with the box-shaped parcel 10. However, the scanning device 24 is designed to fit a cubical shape around the exterior dimensions of the parcel 110. As a result, because the scanning device 24 establishes a cubical volume for each parcel, when parcel 110 passes therethrough, the scanning device 24 may establish a volume that is greater than the actual volume of the parcel 110. For this reason, the actual dimensions, or actual volume, received from the label 22 or selected by the operator are processed to override any volume obtained by the scanning device 24 so that the lowest volume measurement is used by the computer system 18 to select the most appropriate shipping carrier for the parcel 110. Thus, for unusually-shaped parcels such as the parcel 110, the actual volume of the parcel 110 rather than any measured cubic volume of the parcel 110 is used to select the appropriate shipping carrier.

The parcel 110 then travels to the weighing device 26 where the actual weight of the parcel is measured. The computer system 18 then selects an appropriate shipping carrier, such as the least expensive carrier, and a label 27 is printed at the printer 28 for parcel 110. The operator 30 then applies the label 27 to the parcel 110 (or the label application is automated) and the parcel 110 is directed to proceed to the loading dock where it is shipped to its final destination.

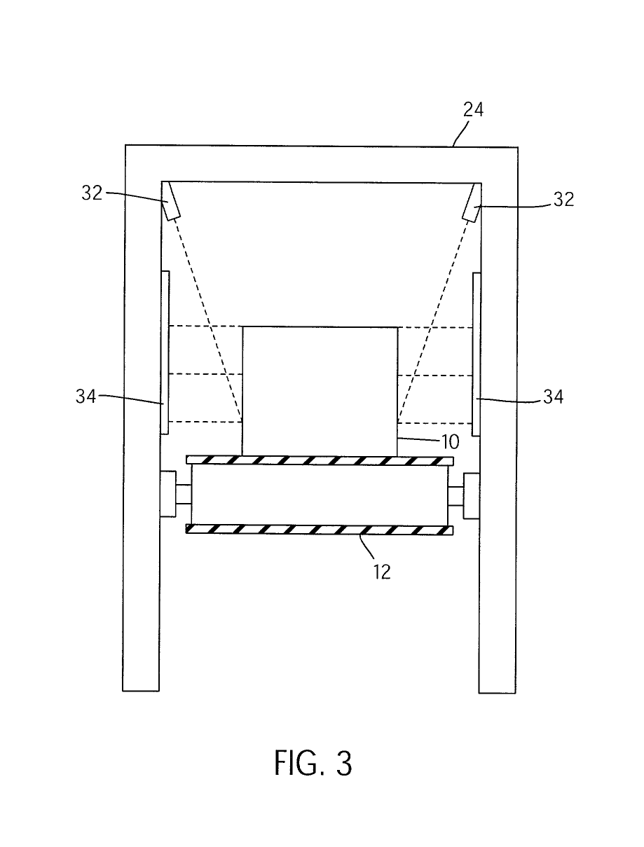

One embodiment of the scanning device 24 is illustrated in FIG. 3. As shown, the scanning device 24 includes scanning cameras 32 and height scanning devices 34 that examine the parcel as it passes through the scanning device 24 on the conveyor 12. Specifically, the height scanning devices 34 determine the height of the parcel and the scanning cameras 32 determine the width of the parcel as it passes through the scanning device 24. For example, the scanning cameras 32 can measure the width of the parcel at or near the bottom of the parcel. As shown in FIG. 3, the scanning cameras 32 can determine the point of intersection between a horizontal beam and the side wall of the parcel, in order to determine the width of the parcel at or near its bottom. In FIG. 3, the lowermost horizontal beam generated from the scanning device 34 is coincided with the beam that is generated for determining the width of the parcel. Moreover, the scanning cameras 32 and height scanning devices 34 do not necessarily produce signals that are used to calculate the cubic volume, since it may be determined that other dimensions and/or calculations would be more appropriate. In one embodiment, the height scanning devices 34 and the scanning cameras 32 determine these measurements by directing scanning beams towards the parcel. The beams that reflect off the parcel and return to the respective device/camera are utilized to determine the respective height/width. For another embodiment, the scanning device 24 may employ cameras 32 that examine the parcel 10, 110 and determine the size of the parcel 10, 110 based on the image generated by the camera. Other scanning methods may also be employed, as would be known to those skilled in the art. The height scanning devices 34 also measure the length of the parcel with a timed measurement. With the speed of the conveyor known, the device 34 may utilize a single beam array to measure how long the beam reflects off or is blocked by the parcel as the parcel passes thereby. The speed of the conveyor multiplied by the reflection or blocking time will determine the length of the parcel. The scanning device 24 provides the length, width, and height information to the computer system 18, which determines the volume information of the parcel.

Combining shipments together, the system 18 can also determine whether two or more parcels having common invoice information should be sent together or separately. For example, the computer readable information of the next processed parcel is compared with that of at least one previously processed parcel. If the information is the same, the carrier cost schedule of the previously processed parcel is utilized to process the two parcels together in order to determine the incremental cost increase for adding the additional weight and/or volume (or any other parameter that a carrier can use for its cost schedule) of the next processed parcel with that of the previously processed parcel. If the cost increase is less than the cost for the next processed parcel by itself, then the previously used carrier is used again for the next processed parcel. The group rate is determined by determining a combined weight and/or combined volume for all the parcels having the same computer readable information. A label is then printed for each subsequent parcel. At the end of the day (or predetermined period of time) when all of the parcels have been processed and labeled, the appropriate carrier is notified for tracking purposes. This aspect of the invention can also apply to determining whether orders should be sent together or separately. An order may include one or more parcels.

For further optimization, printing of the labels can be postponed until the end of the day (or a predetermined period of time). In this embodiment, all processed parcels are presorted according to their destination, and all of the information is then re-processed to determine whether any parcels or orders should be sent separately or together with the same carrier. Once the information is re-processed, labels are printed.

As aforesaid, the computer system 18 may select an appropriate carrier by searching through cost schedules for various carriers within the system 18. Specifically, the computer shipping cost information regarding the plurality of shipping carriers is inputted in the computer system 18 and selecting the appropriate carrier includes matching one of the shipping carriers having the desired shipping parameters based on the computer-readable information, the weight, and the volume of the parcel. It is contemplated that the computer system 18 may select the least expensive shipping carrier for the parcel via the internet.

It is contemplated that the computer-readable information may include a number of articles contained within the parcel, the articles having a known weight per unit. The computer system 18 may confirm that the predetermined number of articles is in the parcel by comparing the measured weight of the parcel to a known weight per article times the number of articles. For example, if the parcel contains 50 bolts, a bolt having a known weight of 2 ozs., the system 18 will expect the parcel to weigh about 100 ozs. If the parcel weighs 120 ozs. after passing through the weighing station, the system 18 will sound an alarm to remove the parcel and to check the contents.

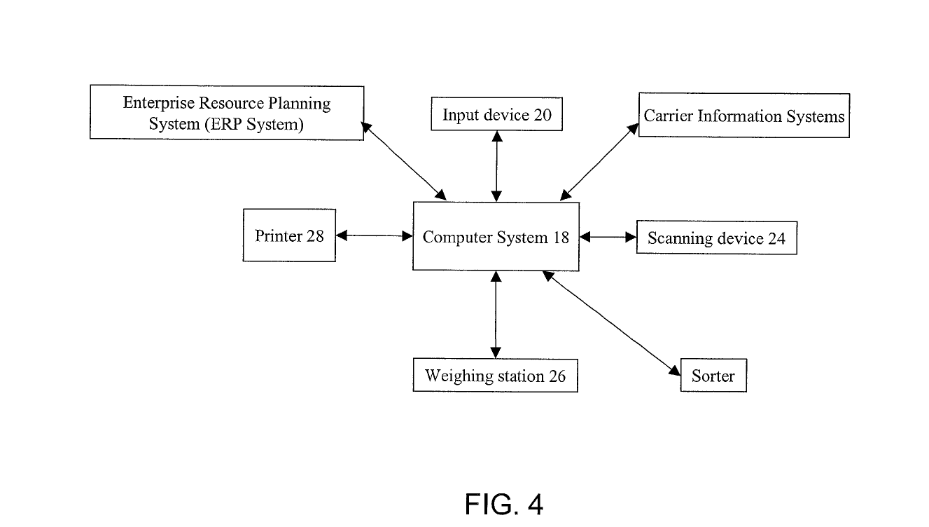

FIG. 4 is a schematic diagram illustrating the exemplary system 11 in accordance with the present invention. As shown, the information that the input device 20, scanning device 24, and weighing device 26 collects is directed to and inputted in the computer system 18. The computer system 18, after selecting an appropriate or least expensive carrier based on a search conducted by the computer system 18 that utilizes the received information, sends a signal to the printer 28 to print shipping labels based on the selected carrier. The computer system 18 may also signal the sorter so that the sorter may direct the parcel in the correct direction after it has been labeled. Any other computing system may also signal the computer system 18 to consider group rates if it is recognized that common carriers are being utilized, and the computer system 18 may provide a signal to the scanning device 24 to disable cubic volume measurement in the override mode for unusually-shaped parcels. Moreover, all components of the system 11 are capable of bi-directional communication. The computer system 18 can also override the selection (based on the specific needs of the customer) to select a specified carrier or one which offers certain services (this being of course a more appropriate carrier). Those services could be COD, guaranteed delivery, signature upon delivery, etc. Thus, the computer system 18 can be configured or customized to react to any other information (other than the computer readable information, weight, and volume) to select the most appropriate carrier in the circumstances.

The computer system 18 is also in communication with Carrier Information Systems. For example, shipping information and/or costs for each carrier can be obtained from a web-site. Further, the computer system 18 is in communication with a memory that contains the shipping information of each parcel. The shipping information can be used by a software program, e.g., Enterprise Resources Planning (ERP) System, that can be used to track shipment and location of individual parcels. The ERP is commercially available. Using the ERP system, a user can key in the order to track shipment.

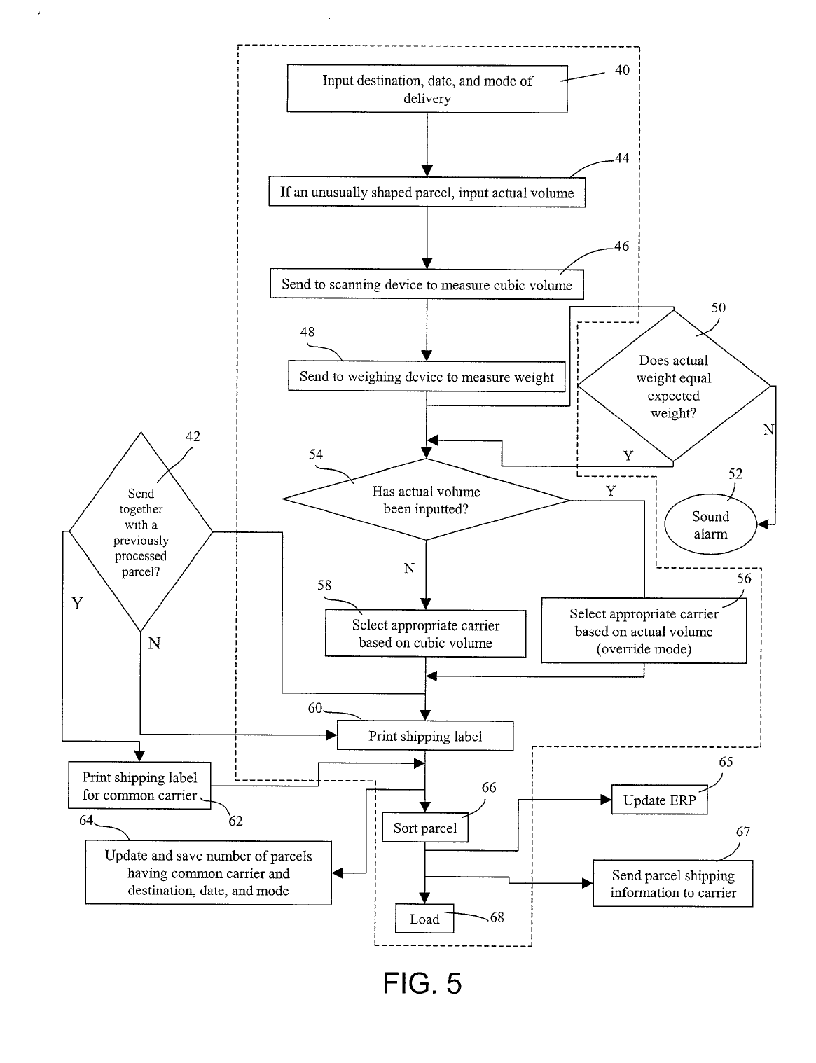

FIG. 5 is a flow chart illustrating an exemplary shipping method in accordance with the present invention. The method begins at 40 at which computer-readable information in the form of a bar-coded label provided on the outer surface of a parcel or associated with the parcel but not attached thereto (i.e., at least associating computer-readable information with the parcel via an associated order request) is read by the input device so as to input the destination, date and mode of delivery into the computer system. Then, the computer system determines if the actual volume must override the measured volume, e.g., if the parcel is unusually shaped, and inputs the actual volume at 44. The actual volume is provided on the label or is provided by the computer system after the operator manually inputs the container type.

The parcel is sent along the conveying path to the scanning device at 46 to measure the cubic volume. Then, the parcel is sent to the weighing device at 48 to measure the weight. After the weight is measured, the computer system may determine if the actual weight approximately equals the expected or known weight at 50 in order to verify the contents of the parcel. If the actual weight of the parcel does not approximately equal the known weight, an alarm is sounded at 52 and that parcel is removed from the system to check the contents. If the actual weight does equal the known weight, the computer system determines if the actual volume has been inputted at 54. If the actual volume has been inputted, then the computer system recognizes that the parcel is unusually shaped and selects an appropriate carrier at 56, such as the least expensive carrier, based on the actual volume. The actual volume overrides any volume obtained from the scanning device 24. If the actual volume has not been inputted, then the computer system recognizes that the parcel is box shaped and selects an appropriate carrier at 58, such as the least expensive carrier, based on the cubic volume, or volume determined from the scanning device.

At 42, the computer system considers if the parcel should be sent together with or separately from at least one previously processed parcel having common computer readable information. Specifically, the computer readable information of each parcel is compared with that of at least one previously processed parcel. If the information is the same, the carrier cost schedule of the previously processed parcel is utilized to process the two parcels together in order to determine the incremental cost increase for adding the additional weight and volume of the parcel with that of the previously processed parcel. If the cost increase is less than the cost for the parcel by itself, then the parcel should be sent together with the previously processed parcel. A shipping label is printed at 62 for the common carrier and the parcel is directed to be sorted at 66 and loaded at 68. If the cost for the parcel itself is less than the cost increase for adding the parcel with the previously processed parcel, then the parcel should be sent separately from the previously processed parcel. The shipping label for the appropriate carrier for the parcel itself is printed and attached to the parcel at 60. The parcel is sorted at 66, by carrier for example, and loaded at 68 for delivery. Prior to the parcel being sorted and then loaded, the computer system may update and save the number of parcels having a common carrier and destination, date, and mode information at 64. This information is then used by the computer system to consider group rates for the subsequent parcels. Further, the ERP system can be updated at 65, and the parcel shipping information may be sent to the carrier at 67. Of course, steps 65 and 67 may be carried out after loading (step 68) or before sorting (step 66), depending on need.

As mentioned above, for further optimization, the parcels or orders can be presorted, and labels can be printed at the end of the day or a predetermined amount of time, to consider whether parcels or orders should be sent together with the same carrier or separately using different carriers.

Since the shipping process described above is computerized, the parcel may be tracked via the internet or telephone in order to confirm shipping and verify delivery. A database may also be created in order to generate various reports, such as cost analysis. Tracking may be accomplished and/or the database may be created with the ERP system, described above.

The foregoing specific embodiments have been provided to illustrate structural and functional principles of the present invention and is not intended to be limiting. The present invention is intended to encompass all modifications, alterations, and substitutions within the spirit and scope of the disclosed embodiments.

What is claimed is

1. A method for determining an appropriate shipping carrier for a plurality of shipping carriers for a parcel, comprising:
providing computer-readable information relating to at least one of a destination, delivery date, and delivery mode of the parcel;
obtaining a volume of the parcel;
measuring a weight of the parcel;
inputting the computer-readable information, weight, and volume into a computer; and
selecting the appropriate shipping carrier for the parcel based on the computer-readable information, weight, and volume.

2. A method according to claim 1, wherein the computer-readable information includes a predetermined number of articles contained within the parcel, the method further comprising comparing the measured weight to a known weight per article times the number of articles to confirm that the predetermined number of articles is in the parcel.

3. A method according to claim 1, wherein the computer-readable information includes an actual volume of the parcel, and the actual volume of the parcel rather than any measured volume of the parcel is used to select the appropriate shipping carrier.

4. A method according to claim 3, wherein the measured volume of the parcel is the cubic volume of the parcel.

5. A method according to claim 1, wherein the appropriate carrier is the least expensive carrier.

6. A method according to claim 1, further comprising:
comparing the computer-readable information of a next processed parcel with that of at least one previously processed parcel;
utilizing a cost schedule of the appropriate shipping carrier for the previously processed parcel, if the computer-readable information of the next processed parcel is the same as the previously processed parcel, to determine an incremental cost increase for adding at least one of the additional weight, volume, and another carrier cost schedule parameter of the next processed parcel with that of the previously processed parcel; and
selecting the shipping carrier of the previously processed parcel for the next processed parcel if the incremental cost increase is less than a cost for the next processed parcel by itself.

7. A method according to claim 1, further comprising:
inputting into the computer shipping cost information regarding the plurality of shipping carriers,
wherein the selecting the appropriate carrier includes matching one of the shipping carriers having the least expensive shipping cost information based on the computer-readable information, the weight, and the volume of the parcel.

8. A method according to claim 1, further comprising:
attaching a label to the parcel; and
directing the parcel to the appropriate shipping carrier.

9. A method for determining the least expensive shipping carrier for a parcel, comprising:
preparing an invoice having bar coded information that includes at least one of a delivery destination, a delivery date, and a delivery mode of the parcel;
utilizing a bar code scanner to read the invoice and to input the information into a computer system;
measuring dimensions of the parcel to determine a volume of the parcel and inputting the dimensions into the computer system;
weighing the parcel and inputting the weight into the computer system; and
selecting the least expensive shipping carrier for the parcel based on a search conducted by the computer system that utilizes the information, the dimensions, and the weight of the parcel.

10. A method according to claim 9, wherein the measured dimensions of the parcel are the cubic dimensions of the parcel.

11. A method according to claim 9, further comprising:
preparing and attaching to the parcel a shipping label for the least expensive shipping carrier; and
shipping the parcel to the delivery destination.

12. A method according to claim 9, further comprising tracking the delivery of the parcel via internet or telephone.

13. A method according to claim 9, further comprising verifying contents of the parcel by comparing an approximate known weight of the contents to the actual weight of the parcel.

14. A method according to claim 9, wherein selecting the least expensive shipping carrier for the parcel is conducted by the computer system via the internet.

15. A method according to claim 9, further comprising:
comparing the computer-readable information of a next processed parcel with that of at least one previously processed parcel;
utilizing a cost schedule of the appropriate shipping carrier for the previously processed parcel, if the computer-readable information of the next processed parcel is the same as the previously processed parcel, to determine an incremental cost increase for adding at least one of the additional weight, volume, and another carrier cost schedule parameter of the next processed parcel with that of the previously processed parcel; and
selecting the appropriate shipping carrier of the previously processed parcel for the next processed parcel if the incremental cost increase is less than a cost for the next processed parcel by itself.

16. A method according to claim 9, wherein the actual volume of the parcel is included on or calculated from the invoice and overrides any measured cubic dimensions.

17. A system for determining a most appropriate shipping carrier for a parcel, comprising:
an input device constructed and arranged to read an invoice associated with the parcel as the parcel moves along a conveying path, said invoice having bar coded information that includes at least one of a delivery destination, a delivery date, and a delivery mode of the parcel;
a scanning device provided along the path, said scanning device constructed and arranged to measure the dimensions of the parcel to determine the volume of the parcel;
a weighing device along the path, said weighing device constructed and arranged to determine the weight of the parcel; and
a computer system to receive the information obtained by the input device, the scanning device, and the weighing device as the parcel moves along the path, the computer system selecting the most appropriate shipping carrier for the parcel based on a search conducted by the computer system that utilizes the information, the volume, and the weight of the parcel.

18. A system according to claim 17, further comprising a shipping label printer along the path, the shipping label printer constructed and arranged to prepare a shipping label for the parcel of the most appropriate shipping carrier.

19. A system according to claim 17, further comprising a conveyor system to move the parcel along the path past the input device, the scanning device, the weighing device, and the shipping label printer.

20. A system according to claim 17, wherein the computer system verifies contents of the parcel by comparing a known weight of the contents to the actual weight of the parcel based on the weighing device.

21. A system according to claim 17, wherein the invoice includes the actual volume of the parcel, the actual volume on the invoice overriding any volume obtained by the scanning device.

22. A system according to claim 17, wherein the measured volume of the parcel is the cubic volume of the parcel.

23. A system according to claim 17, wherein the most appropriate shipping carrier is the least expensive shipping carrier.
